(19) United States
(12) Patent Application Publication
(10) Pub. No.: US 2024/0303543 A1
(43) Pub. Date: Sep. 12, 2024

(54) MODEL TRAINING METHOD AND MODEL TRAINING APPARATUS

(71) Applicant: PEGATRON CORPORATION, TAIPEI CITY (TW)

(72) Inventor: Jonathan Guo, Taipei City (TW)

(73) Assignee: PEGATRON CORPORATION, TAIPEI CITY (TW)

(21) Appl. No.: 18/523,498

(22) Filed: Nov. 29, 2023

(30) Foreign Application Priority Data
Mar. 8, 2023 (TW) 112108590

(51) Int. Cl. G06N 20/00

(52) U.S. Cl. CPC G06N 20/00

(57) ABSTRACT

A model training method and a model training apparatus are provided. In the method, a pre-trained model, an old dataset, and a new dataset are obtained. The pre-trained model is a machine-learning model trained by using the old dataset. The old dataset includes a plurality of old training samples. The new dataset includes a plurality of new training samples. The training of the pre-trained model has not yet used the new dataset. The old training samples of the old dataset are reduced to generate a reduced dataset. The reduced dataset and the new dataset are used to tune the pre-trained model. Accordingly, the training efficiency of fine-tuning can be improved.

### CROSS-REFERENCE TO RELATED APPLICATION

This application claims the priority benefit of Taiwan application serial no. 112108590, filed on Mar. 8, 2023. The entirety of the above-mentioned patent application is hereby incorporated by reference herein and made a part of this specification.

### BACKGROUND

### Technical Field

The disclosure relates to a machine learning technology, and in particular to a model training method and a model training apparatus.

### Description of Related Art

FIG. 1 is a flow chart of model training Referring to FIG. 1, a model training process includes collecting training data (Step S110), merging the data (Step S120), training the model (Step S130), offline evaluation (Step S140), deployment (Step S150), monitoring the performance (Step S160), and failure analysis (Step S170). Also, in order to improve the performance of the deep learning model, it is often necessary to collect new training data (Step S180) to fine-tune the deep learning model for a newly discovered scenario. At this time, the new training data is added to the original dataset due to the newly discovered scenario, and then the new training data and the original dataset are used to continue the training in the original model (Step S120). In this way, the tuned model can learn the new scenario to improve the robustness and performance.

However, after using the above training process for a long time, the following problems are likely to occur since the system continuously adds new data into the dataset:
(1) The space for storing the dataset is continuing to grow up.
(2) The training time for training the model is increased due to a large training dataset.
(3) It is difficult to track and manage the dataset including the newly discovered scenarios.

### SUMMARY

In view of this, an embodiment of the disclosure provides a model training method and a model training apparatus which can appropriately reduce the amount of training data to improve the training efficiency.

The model training method according to an embodiment of the disclosure may be implemented by a processor. The model training method includes (but is not limited to) the following. A pre-trained model, an old dataset, and a new dataset are obtained. The pre-trained model is a machine-learning model trained by using the old dataset. The old dataset includes multiple old training samples. The new dataset includes multiple new training samples. The training of the pre-trained model has not yet used the new dataset. The old training samples of the old dataset are reduced to generate a reduced dataset. The reduced dataset and the new dataset are used to tune the pre-trained model.

The model training apparatus according to an embodiment of the disclosure includes (but is not limited to) a memory and a processor. The memory is configured to store a program code. The processor is coupled to the memory. The processor executes the program code and is configured to obtain a pre-trained model, an old dataset, and a new dataset, reduce old training samples in the old dataset to generate a reduced dataset, and use the reduced dataset and the new dataset to tune the pre-trained model. In the step of obtaining the pre-trained model, the old dataset, and the new dataset, the pre-trained model is a machine-learning model trained by using the old dataset, the old dataset includes multiple old training samples, the new dataset includes multiple new training samples, and the training of the pre-trained model has not yet used the new dataset.

Based on the above, according to the model training method and the model training apparatus of the embodiments of the disclosure, the old training samples are reduced, and the reduced old dataset and the new dataset are used to tune the pre-trained model. In this way, the efficiency of data usage is improved and the training efficiency can be improved.

In order to make the above-mentioned features and advantages of the disclosure more comprehensible, the embodiments are described in detail below with reference to the accompanying drawings.

### BRIEF DESCRIPTION OF THE DRAWINGS

FIG. 1 is a flow chart of model training.

FIG. 2 is a block diagram of a model training apparatus according to an embodiment of the disclosure.

FIG. 3 is a flow chart of a model training method according to an embodiment of the disclosure.

FIG. 4 is a flow chart of determining model association according to an embodiment of the disclosure.

FIG. 5A is a data distribution diagram of training data according to an embodiment of the disclosure.

FIG. 5B is a schematic diagram of data reduction according to the first embodiment of the disclosure.

FIG. 5C is a schematic diagram of data reduction according to the second embodiment of the disclosure.

FIG. 6 is a flow chart of data merge according to an embodiment of the disclosure.

FIG. 7 is a flow chart of data association according to an embodiment of the disclosure.

FIG. 8 is an overall flow chart of the model training according to an embodiment of the disclosure.

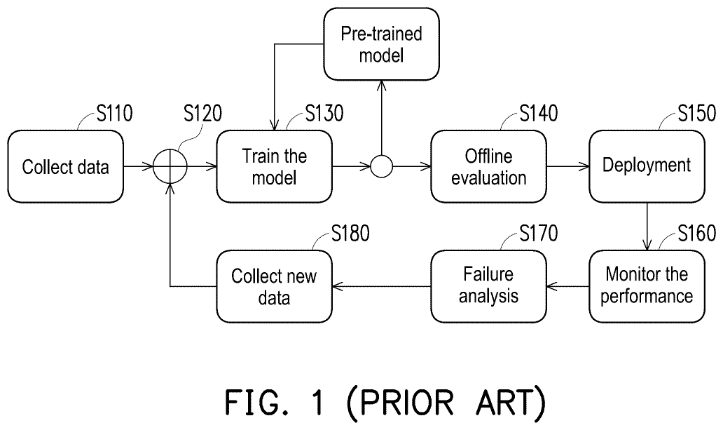

### DESCRIPTION OF THE EMBODIMENTS

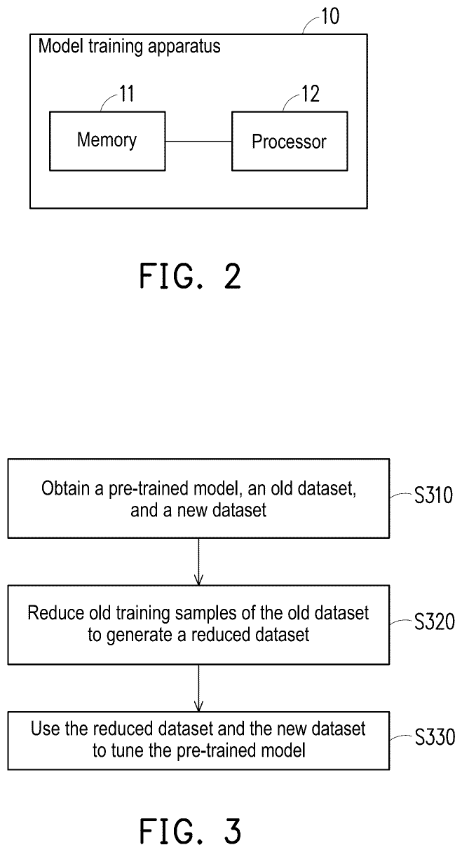

FIG. 2 is a block diagram of a model training apparatus according to an embodiment of the disclosure. Referring to FIG. 2, a model training apparatus 10 includes (but is not limited to) a memory 11 and a processor 12. The model training apparatus 10 may be a desktop or laptop computer, a server, a smartphone, a tablet computer, a wearable device, or other computing devices.

The memory 11 may be any types of fixed or removable random access memory (RAM), read only memory (ROM), flash memory, hard disk drive (HDD), solid-state drive (SSD), or similar elements. In an embodiment, the memory 11 is configured to store program codes, software modules, configuration arrangements, data, or files (for example, training data, models, or parameters), which will be detailed in subsequent embodiments.

The processor 12 is coupled to the memory 11. The processor 12 may be a central processing unit (CPU), a graphic processing unit (GPU), or other programmable general or special purpose microprocessors, digital signal processors (DSP), programmable controllers, field programmable gate arrays (FPGA), application-specific integrated circuits (ASIC), neural network accelerators, or other similar elements or combinations of the above elements. In an embodiment, the processor 12 is configured to execute all or part of operations of the model training apparatus 10 and may load and execute each program code, software module, file, and data stored in the memory 11.

In the following description, various devices and elements in the model training apparatus 10 will be used to illustrate the method according to the embodiments of the disclosure. Each process of the method may be adjusted according to the implementation situation and is not limited thereto.

FIG. 3 is a flow chart of a model training method according to an embodiment of the disclosure. Referring to FIG. 3, the processor 12 obtains the pre-trained model, the old dataset, and the new dataset (Step S310). Specifically, the pre-trained model is a machine-learning model trained by using the old dataset. Machine learning algorithms (e.g., neural networks, autoencoders, decision trees, or random forests) may be used to train the model. The machine learning algorithms can be used to analyze training samples/data to obtain the rules therefrom, and then predict unknown data through the rules. For example, a machine-learning model establishes the node associations in the hidden layer between the training data and output data according to labeled samples (for example, feature data of a known event). The machine-learning model is a model constructed after learning, and can be used to make inferences on data to be evaluated (for example, the feature data) accordingly. In the embodiment of the disclosure, the pre-trained model can be generated by using the old dataset (and corresponding actual results).

The old dataset includes multiple old training samples. The new dataset is different from the old dataset. The new dataset includes multiple new training samples. That is to say, the old training samples are different from the new training samples. Depending on different application scenarios, the training samples may be sensing data, historical data, or other data. The samples are, for example, texts, images, sounds, or signal waveforms, and the embodiment of the disclosure does not limit the type. The differences between the old training samples and the new training samples may be dates, objects, events, situations, or sensors. For example, the old training sample is a surveillance video of the day before yesterday and yesterday, and the new training sample is a surveillance video of today, the day before yesterday, and yesterday. In addition, the training of the pre-trained model has not yet used the new dataset. That is to say, the pre-trained model is the model that is trained by the old dataset, and without/ignoring the use of the new dataset.

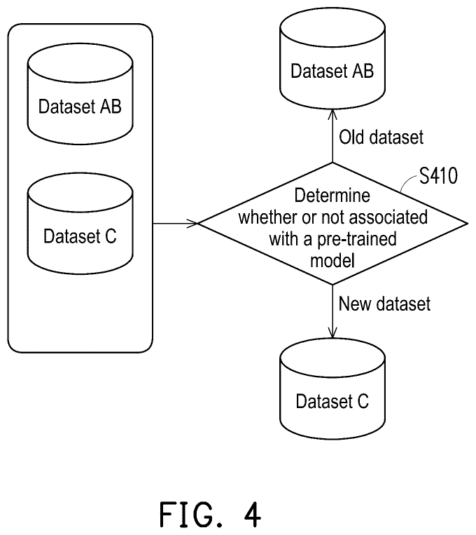

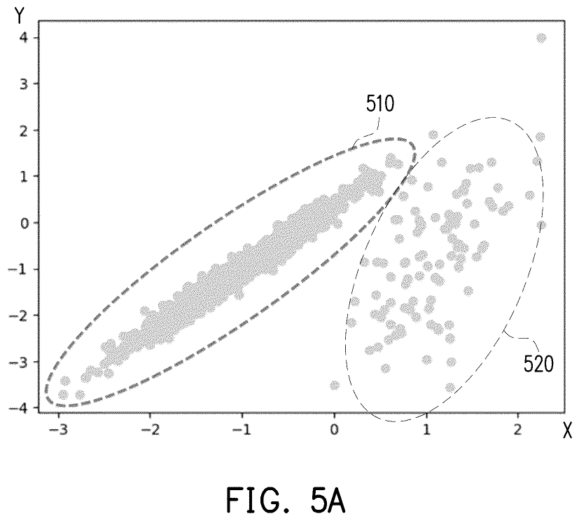

FIG. 4 is a flow chart of determining model association according to an embodiment of the disclosure. Referring to FIG. 4, the processor 12 may determine whether the dataset is associated with the pre-trained model to identify the dataset as a new dataset or an old dataset (Step S410). Since the training data of the pre-trained model is the old dataset, the processor 12 determines that the old dataset is associated with the pre-trained model. As shown in FIG. 4, datasets A and B are old datasets. Since the training data of the pre-trained model has not yet used the new dataset, the processor 12 determines that the new dataset is not associated with the pre-trained model. As shown in FIG. 4, a dataset C is a new dataset.

In an embodiment, the processor 12 may determine that the old dataset has a label associated with the pre-trained model. After the pre-trained model is established, the processor 12 may create a label for the old dataset of the training data, such that the old dataset is associated with the pre-trained model. This label is, for example, identification information or a specific symbol (for example, “0” or “1”) of the pre-trained model. The processor 12 may determine that the pre-trained model was trained by using the old dataset according to the label. That is to say, if the dataset has the label, the processor 12 determines that the dataset is an old dataset used for training the pre-trained model. If the dataset does not have the label, the processor 12 determines that the dataset is a new dataset.

Referring to FIG. 3, the processor 12 reduces the old training samples of the old dataset to generate a reduced dataset (Step S320). Specifically, the processor 12 may select a portion of the old training samples of the old dataset through a specified rule to control the amount of data in the dataset used during the training A collection of the selected old training samples is the reduced dataset.

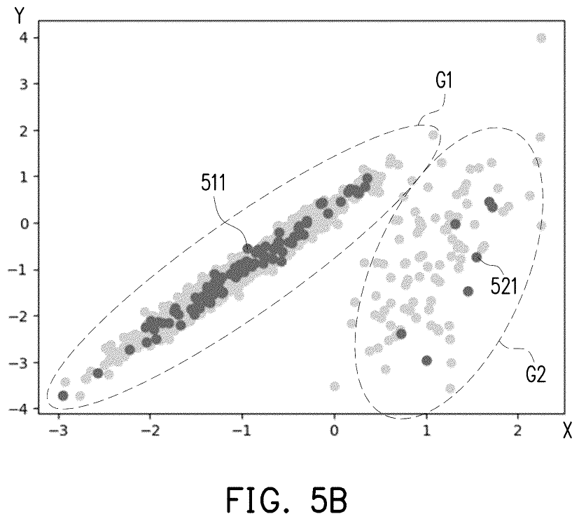

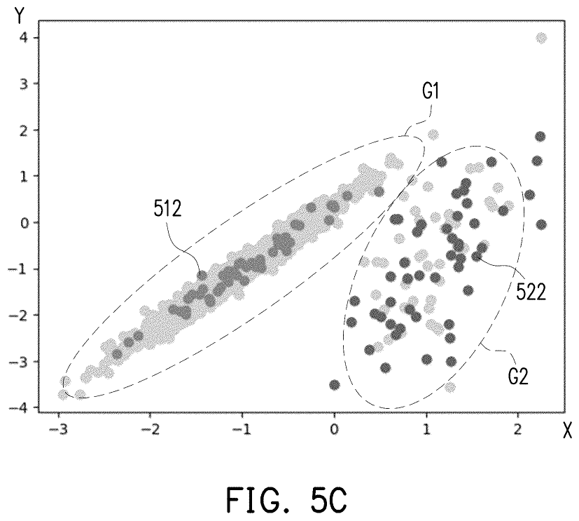

For example, FIG. 5A is a data distribution diagram of the training data according to an embodiment of the disclosure. Please refer to FIG. 5A. Values of the training data are expressed in two dimensions, X and Y, and are merely used for convenience of explanation but not to limit the dimensions. In actual applications, 90% of the data may be located in a region 510, while the other 10% of the data is distributed in a region 520.

In an embodiment, the processor 12 may rearrange a sequence of the old training samples. For example, arrange the sequence randomly, insert data, or arrange the sequence according to other rules. The processor 12 may select a portion of the old training samples according to the rearranged sequence of the old training samples. A quantity of the selected portion is less than the quantity of all old training samples in the old training data, so as to achieve the purpose of data reduction.

For example, FIG. 5B is a schematic diagram of data reduction according to the first embodiment of the disclosure. Please refer to FIG. 5B. Dark points are the selected old training samples and are used to form the reduced dataset accordingly. Since the sequence is randomly arranged, the data distribution of the dark points is similar to FIG. 5A. For example, old training samples 511 in a group G1 (corresponding to the region 510 in FIG. 5A) accounts for approximately 90% of all selected old training samples. Old training samples 521 in a group G2 (corresponding to the region 520 in FIG. 5A) accounts for approximately 10% of all selected old training samples. In this way, the data distribution can be maintained.

In another embodiment, the processor 12 may perform clustering on the old training samples to generate one or more groups. Specifically, the processor 12 can obtain features of each old training sample through a feature extraction algorithm, and perform clustering on the features of the old training samples by using the clustering algorithm. The feature extraction algorithm is, for example, the independent components analysis (ICA), the principal component analysis (PCA), or the partial least squares regression. In addition, the feature extraction algorithm may also be the feature extraction backbone of the original pre-trained model trained by using the old data, or the feature extraction backbone of a pre-trained model trained by using a large amount of data (such as ImageNet). The feature extraction can extract informative and non-redundant derived values (i.e., feature values) from the original data. The clustering algorithm may be the K-means, the Gaussian mixture model (GMM), the mean-shift, the hierarchical clustering method, the spectral clustering algorithm, the DBSCAN (density-based spatial clustering of applications with noise) algorithm, or other clustering algorithms. The clustering algorithm can classify old training samples and classify similar old training samples into the same group. For example, FIG. 5C is a schematic diagram of data reduction according to the second embodiment of the disclosure. Referring to FIG. 5C, the old training samples may be classified into groups the G1 and G2.

Next, the processor 12 may select a portion from the one or more groups. That is, to select a portion of old training samples from each group, and a quantity of the selected portion in each group is less than a quantity of all old training samples in the group, so as to achieve the purpose of data reduction. The processor 12 may select old training samples of the same quantity for each group. Taking FIG. 5C as an example, the dark points are the selected old training samples and are used to form the reduced dataset accordingly. The quantity of the old training samples 512 of the group G1 may be the same as the quantity of the old training samples 522 of the group G2. Compared with the embodiment in FIG. 5B, the quantity ratio of the embodiment in FIG. 5C is balanced. In this way, the diversity of the original data can be maintained.

Referring to FIG. 3, the processor 12 uses the reduced dataset and the new dataset to tune the pre-trained model (Step S330). Specifically, fine-tuning is a further tuning of initial parameters (such as weights or connections) of the pre-trained model. The pre-trained model has the initial parameters trained by the old training samples. When a new dataset is added, the pre-trained model is tuned based on the initial parameters of the pre-trained model to adapt to the new dataset. The tuning (or fine-tuning) of the pre-trained model includes, for example, a full update (that is, using the new dataset to update all datasets) and a partial update (that is, freezing parameters of a specified layer and updating merely a non-frozen portion), but the disclosure is not limited thereto.

In an embodiment, the processor 12 may merge the reduced dataset and the new dataset. For example, the reduced dataset and the new dataset may be merged into one dataset through methods such as concatenation or insertion. Next, the processor 12 uses the dataset that merges the reduced dataset and the new dataset to tune the parameters of the pre-trained model.

In an embodiment, after the tuning of the pre-trained model is completed, the processor 12 may merge the old dataset (or the reduced dataset) and the new dataset to generate another old dataset. For example, the reduced/old dataset and the new dataset may be merged into the other old dataset through methods such as concatenation or insertion to replace the original old dataset.

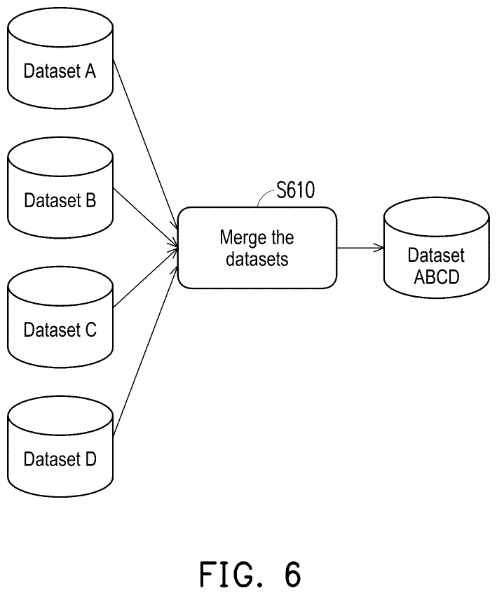

For example, FIG. 6 is a flow chart of data merge according to an embodiment of the disclosure. Referring to FIG. 6, the processor 12 merges the datasets A, B, C, and D to form a dataset ABCD. The dataset ABCD includes all training samples of the datasets A, B, C, and D.

Next, the processor 12 may associate the other old dataset with the pre-trained model. For example, a label is added to the other old dataset. The label may be the identification information or symbol introduced in the embodiment of FIG. 4, and will not be repeated here. In this way, other new datasets added subsequently can be distinguished.

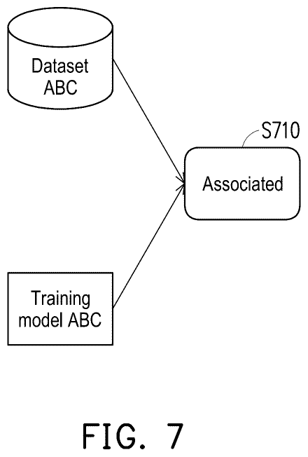

For example, FIG. 7 is a flow chart of data association according to an embodiment of the disclosure. Referring to FIG. 7, a dataset ABC is used to tune a pre-trained model ABC. The processor 12 adds a label to the dataset ABC to associate with the pre-trained model ABC.

In order to help understand the spirit of the disclosure, the overall flow will be described in another embodiment illustrated below.

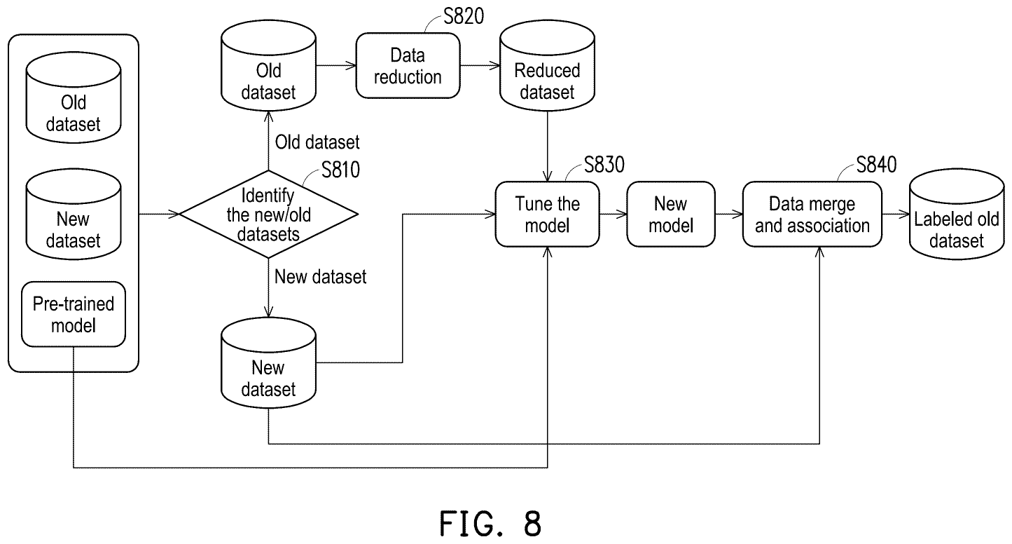

FIG. 8 is the overall flow chart of the model training according to an embodiment of the disclosure. Please refer to FIG. 8. In response to obtaining the old dataset, the new dataset, and the pre-trained model, the processor 12 identifies the old dataset and the new dataset (Step S810). The processor 12 merely reduces the old dataset (Step S820) to generate the reduced dataset. The processor 12 uses the reduced dataset and the new dataset to fine-tune the parameters of the pre-trained model (Step S830) to generate a new model. Next, the processor 12 merges the reduced dataset and the new dataset and associates the merged old dataset with the new model (Step S840) to generate the labeled old dataset. In response to the addition of other new datasets, the above steps may be repeated.

In summary, the model training method and the model training apparatus according to the embodiments of the disclosure include the following features:

A portion of the old training samples in the old dataset is selected to achieve the purpose of data reduction.

A data selection method that maintains the data distribution and maintains the data diversity patterns is provided.

Subsequent fine-tune training can quickly distinguish between the new dataset and the old dataset.

The efficiency of data usage is improved, the model training time is reduced, while the performance of making inferences is maintained.

Although the disclosure has been disclosed above in terms of the embodiments, the embodiments are not intended to limit the disclosure. Persons with ordinary knowledge in the technical field may make some changes and modifications without departing from the spirit and scope of the disclosure. Therefore, the protection scope of the disclosure shall be determined by the appended claims.

What is claimed is:

1. A model training method implemented by a processor, comprising:
obtaining a pre-trained model, an old dataset, and a new dataset, wherein the pre-trained model is a machine-learning model trained by using the old dataset, the old dataset comprises a plurality of old training samples, the new dataset comprises a plurality of new training samples, and training of the pre-trained model has not yet used the new dataset;
reducing the old training samples of the old dataset to generate a reduced dataset; and
using the reduced dataset and the new dataset to tune the pre-trained model.

2. The model training method as claimed in claim 1, wherein reducing the old training samples in the old dataset comprise:
rearranging a sequence of the old training samples; and
selecting a portion of the old training samples according to the rearranged sequence of the old training samples.

3. The model training method as claimed in claim 1, wherein reducing the old training samples of the old dataset comprise:
performing clustering on the old training samples to generate at least one group; and
selecting a portion from the at least one group.

4. The model training method as claimed in claim 3, wherein the at least one group comprises a first group and a second group, and selecting the portion from the at least one group comprises:
selecting old training samples of same quantity from the first group and the second group respectively.

5. The model training method as claimed in claim 1 after tuning the pre-trained model, further comprising:
merging the old dataset and the new dataset to generate another old dataset; and
associating the another old dataset with the pre-trained model.

6. The model training method as claimed in claim 1 after obtaining the pre-trained model, the old dataset, and the new dataset, further comprising:
determining whether the old dataset has a label associated with the pre-trained model; and
determining the pre-trained model that was trained by using the old dataset according to the label.

7. A model training apparatus, comprising:
a memory configured to store a program code; and
a processor coupled to the memory, executing the program code, and configured to:
obtaining a pre-trained model, an old dataset, and a new dataset, wherein the pre-trained model is a machine-learning model trained by using the old dataset, the old dataset comprises a plurality of old training samples, the new dataset comprises a plurality of new training samples, and training of the pre-trained model has not yet used the new dataset;
reducing the old training samples of the old dataset to generate a reduced dataset; and
using the reduced dataset and the new dataset to tune the pre-trained model.

8. The model training apparatus as claimed in claim 7, wherein the processor is further configured to:
rearrange a sequence of the old training samples; and
select a portion of the old training samples according to the rearranged sequence of the old training samples.

9. The model training apparatus as claimed in claim 7, wherein the processor is further configured to:
perform clustering on the old training samples to generate at least one group; and
select a portion from the at least one group.

10. The model training apparatus as claimed in claim 9, wherein the at least one group comprises a first group and a second group, and the processor is further configured to:
select old training samples of same quantity from the first group and the second group respectively.

11. The model training apparatus as claimed in claim 7, wherein the processor is further configured to:
merge the old dataset and the new dataset to generate another old dataset; and
associate the another old dataset with the pre-trained model.

12. The model training apparatus as claimed in claim 7, wherein the processor is further configured to:
determine whether the old dataset has a label associated with the pre-trained model; and
determine the pre-trained model that was trained by using the old dataset according to the label.
